(19) United States
(12) Patent Application Publication
(10) Pub. No.: US 2025/0328522 A1
(43) Pub. Date: Oct. 23, 2025

(54) AUTONOMOUS CONFIGURATION OF CLOUD-BASED APPLICATIONS USING GENERATIVE ARTIFICIAL INTELLIGENCE

(71) Applicant: SAP SE, Walldorf (DE)

(72) Inventors: Naresh Gupta, Saratoga, CA (US); Sheetal Rajgure, Austin, TX (US); FNU Prashant Kumar, San Jose, CA (US); Arun Kumar Dodia, Cupertinoa, CA (US)

(21) Appl. No.: 18/637,525

(22) Filed: Apr. 17, 2024

(51) Int. Cl. G06F 16/242

(52) U.S. Cl. CPC G06F 16/243

(57) ABSTRACT

Methods, systems, and computer-readable storage media for determining a set of queries corresponding to a set of configuration settings of an application, for each query in the set of queries, querying a database to return a set of chunks, each chunk in each set of chunks including a portion of a requirements document, providing a set of prompts, each prompt corresponding to a query in the set of queries and including a respective set of chunks as context, receiving, from a large language model (LLM), a set of responses, each response corresponding to a prompt in the set of prompts, querying a knowledge graph based on the set of responses to provide a set of knowledge graph results, providing a configuration file using the set of responses and the set of knowledge graph results, and configuring the application using the configuration file.

### BACKGROUND

Software systems can be provisioned by software vendors to enable enterprises to conduct operations. Software systems can include various applications that provide functionality for execution of enterprise operations. In some instances, software systems can include or operate in association with a database system. Applications can be provided in an application layer that overlies a database system and enable interactions with the database system (e.g., reading data, writing data, manipulating data). Applications can be provisioned for multiple disparate enterprises. For example, instances of an application can be hosted in a cloud-computing environment and different enterprises can interact with different instances of the application. Different enterprises, however, can have different requirements for use of an application. As such, applications can be configured for specific needs of an enterprise. To this end, an application can be associated with a set of configuration settings, and each enterprise can configure the application to its particular needs.

### SUMMARY

Implementations of the present disclosure are directed to configuring applications that are executed in cloud-computing environments. More particularly, implementations of the present disclosure are directed to an application configuration system that provides autonomous configuration of applications using generative artificial intelligence (GAI).

In some implementations, actions include determining a set of queries corresponding to a set of configuration settings of an application, for each query in the set of queries, querying a database to return a set of chunks, each chunk in each set of chunks including a portion of a requirements document, providing a set of prompts, each prompt corresponding to a query in the set of queries and including a respective set of chunks as context, receiving, from a large language model (LLM), a set of responses, each response corresponding to a prompt in the set of prompts, querying a knowledge graph based on the set of responses to provide a set of knowledge graph results, providing a configuration file using the set of responses and the set of knowledge graph results, and configuring the application using the configuration file. Other implementations of this aspect include corresponding systems, apparatus, and computer programs, configured to perform the actions of the methods, encoded on computer storage devices.

These and other implementations can each optionally include one or more of the following features: each response in the set of responses includes computer-executable code for a respective configuration setting in the set of configuration settings; each query in the set of queries includes a natural language query corresponding to a configuration setting in the set of configuration settings; at least one knowledge graph result includes a set of dependencies associated with a configuration setting in the set of configuration settings; actions further include determining a query corresponding to a configuration setting that has been added to the set of configuration settings of the application, querying the database to return a set of chunks responsive to the query, providing a prompt corresponding to the query and including the set of chunks as context, receiving, from the LLM, a response corresponding to the prompt, and using the response, configuring the configuration setting that has been added to the set of configuration settings of the application; the query is added to the set of queries in response to addition of the configuration setting to the set of configuration settings; actions further include providing an initial configuration file based on the set of responses, and updating the initial configuration file using the set of knowledge graph results to provide the configuration file.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts another example architecture in accordance with implementations of the present disclosure.

FIGS. 3A and 3B depict an example flow diagrams representative of example use cases in accordance with implementations of the present disclosure.

FIG. 4 is a flowchart depicting an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to configuring applications that are executed in cloud-computing environments. More particularly, implementations of the present disclosure are directed to an application configuration system that provides autonomous configuration of applications using generative artificial intelligence (GAI). Implementations can include actions of determining a set of queries corresponding to a set of configuration settings of an application, for each query in the set of queries, querying a database to return a set of chunks, each chunk in each set of chunks including a portion of a requirements document, providing a set of prompts, each prompt corresponding to a query in the set of queries and including a respective set of chunks as context, receiving, from a large language model (LLM), a set of responses, each response corresponding to a prompt in the set of prompts, querying a knowledge graph based on the set of responses to provide a set of knowledge graph results, providing a configuration file using the set of responses and the set of knowledge graph results, and configuring the application using the configuration file.

To provide further context for implementations of the present disclosure, and as introduced above, applications can be provisioned for multiple disparate enterprises. For example, an application can be hosted in a cloud-computing environment and different enterprises can interact with different configurations of the application. Different enterprises, however, can have different requirements for use of an application. As such, each application has a set of configuration settings associated therewith, which can be configured for specific needs of respective enterprises. To this end, each enterprise can configure the application to its particular needs by setting values of the set of configuration settings to meet the particular needs of the enterprise. Configuring such applications can involve a requirements process that produces a requirements document to define requirements of an enterprise that is to leverage an application in its operations. The requirements document can define settings, functions, processes. and the like to be provisioned by an application as well as selection of numerous detailed functionality requirements. The requirements document can be used to configure the application for the particular needs of the enterprise.

However, applications can be relatively complex, which results in a corresponding complexity in configuring applications and a relatively large number of configuration settings in the set of configuration settings. For example, in view of the complexity and numerosity of configuration settings, configuring the application can be time- and resource-intensive. For example, one or more users spend a significant amount of time online (consuming technical resources) to configure the application. Further, configuration can require several subject matter experts to expend resources in considering and reviewing dozens or even hundreds of requirements defined in the requirements document when configuring the application. Also, if improperly configured, the application will not function properly and/or meet the requirements of the enterprise.

In view of the above context, implementations of the present disclosure provide an application configuration system that provides autonomous configuration of applications using GAI. More particularly, the application configuration system includes an intelligent configuration manager (ICM) that processes a requirements document to provide prompts that are used to prompt a GAI system, which returns configuration code responsive to the prompts. In some examples, the configuration code is executable to configure an application responsive to requirements of the requirements document.

In the field of artificial intelligence (AI), GAI has recently seen an explosion in popularity. At a high level, GAI can be described as foundation models that generate content based on training data. A foundation model can be described as a general-purpose GAI model, such as a large deep learning neural networks, that is trained using broad range of generalized, unlabeled training data and that is capable of performing a multitude of general tasks (e.g., generating text, generating images, conversing in natural language, generating video, generating audio). In some cases, applications are built on top of foundation models. In some examples, multiple foundation models can be used to perform a range of functionality for an application.

Foundation models can include, for example, LLMs, which are a form of GAI that can be used to generate text for a variety of use cases. A LLM can be described as an advanced type of language model that is trained using deep learning techniques on massive amounts of text data. The text data is general and not specific to any particular domain. LLMs can generate various types of text including computer-executable code. In general, the term LLM refers to models that use deep learning techniques and have many parameters, which can range from millions to billions. LLMs can capture complex patterns in language and produce text that is often indistinguishable from that produced by humans. This data is processed through a deep learning architecture, such as a recurrent neural network (RNN) or a transformer model.

In terms of leveraging GAI in workflows, such as application configuration, this is a non-trivial task that presents various technical challenges and can have disadvantages that have to be managed. In the context of configuring applications, issues arising can include, but are not limited to, accounting for all requirements defined in requirements documents and accuracy in the configuration code. Further, GAI models are not specific to any particular domain (e.g., application configuration) and are only as up-to-date as of training. Consequently, there is a knowledge gap between GAI models and specific domains. This knowledge gap expands as data within domains changes over time (e.g., changes to data, new data) arising in a specific domain. To account for such dynamics, GAI models could be re-trained with the most-recent data. However, retraining of GAI models is time- and resource-intensive and is impractical to implement on a regular basis. Further, re-training does not resolve the issue of generality of GAI models (i.e., not trained for application configuration).

To address such technical challenges, among others, implementations of the present disclosure use retrieval augmented generation (RAG) to augment GAI models with additional knowledge, such as domain-specific knowledge. In the context of the present disclosure, and as described in further detail herein, RAG can include receiving a requirements document, retrieving domain-specific data that is relevant to requirements of the requirements document, and using the domain-specific data as context for prompting a GAI model to output computer-executable configuration code. In this manner, domain-related knowledge gaps of the GAI models can be mitigated and output of the GAI models can include up-to-date data relevant to a application configuration.

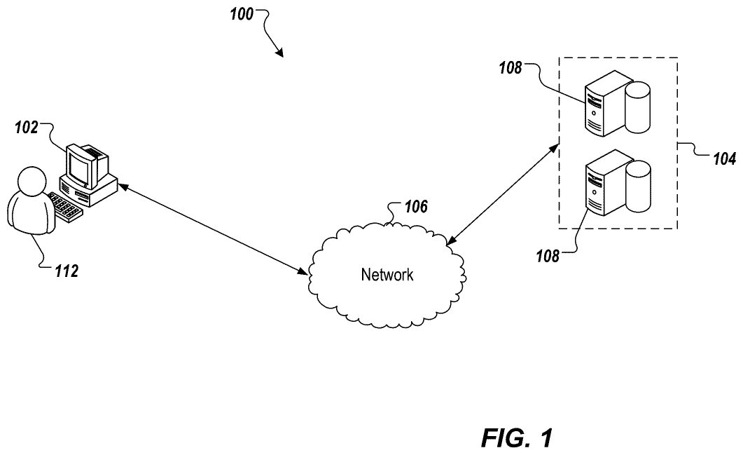

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host an application configuration system for autonomously configuring applications, as described in further detail herein. In some examples, the server system 104 hosts one or more applications that are to be configured. In some examples, the server system 104 hosts a GAI system that is leveraged by the application configuration system to configure the one or more applications. For example, and as described in further detail herein, the application configuration system processes a requirements document (e.g., received from the user 112), generates prompts based on the requirements document and prompts the GAI system, which returns configuration code responsive to the prompts. In some examples, the configuration code is executable to configure the one or more applications responsive to requirements of the requirements document.

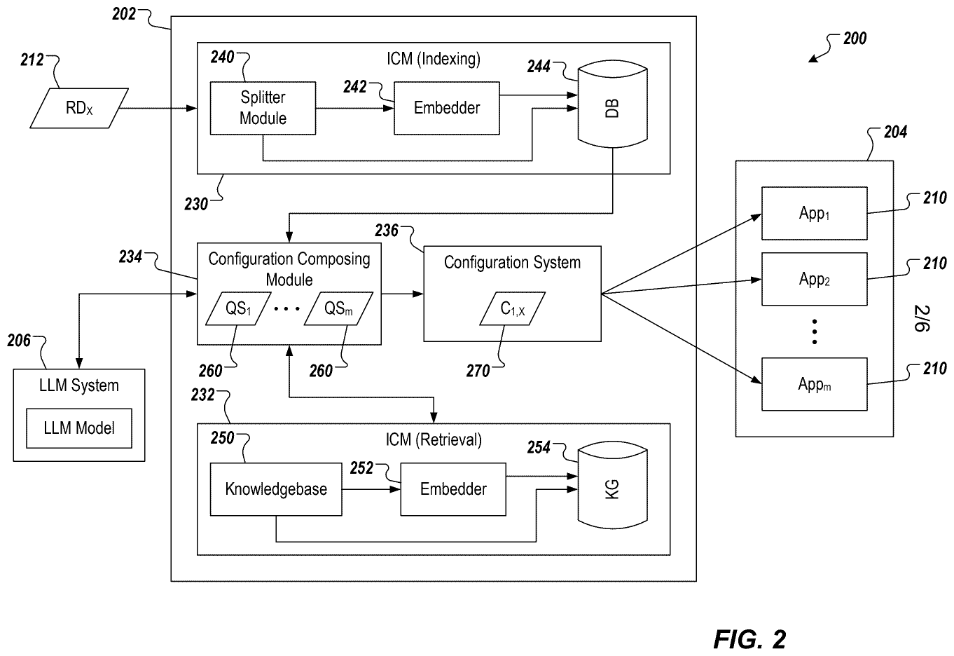

FIG. 2 depicts an example architecture 200 in accordance with implementations of the present disclosure. In the depicted example, the architecture 200 includes an application configuration system 202, a cloud-computing infrastructure 204 and a LLM system 206. The cloud-computing infrastructure 204 hosts applications 210. As described in further detail herein, the application configuration system 202 processes a document 212, such as a requirements document (RD), to autonomously configure one or more of the applications executed in the cloud-computing infrastructure 204. Here, the requirements document 212 can be provided for a particular enterprise (e.g., enterprise X) and is used to configure an application 210 to the specifics of the particular enterprise, as represented in the requirements document 212. In the example of FIG. 2, the application configuration system 202 includes an intelligent configuration manager (ICM) that can include an ICM indexing component 230 and an ICM retrieval component 232. The application configuration system 202 further includes a configuration composing module 234 and a configuration system 236.

In some implementations, the ICM indexing component 230 includes a splitter module 240, an embedder 242, and a database 244. In some examples, the splitter module 240 splits the requirements document 212 into segments, referred to as chunks, the embedder 242 generates embeddings of the chunks, and the database 244 stores the chunks and respective embeddings. As described in further detail herein, one or more chunks can be retrieved based on embeddings and can be used to prompt the LLM system 206.

In further detail, the splitter module 240 splits the requirements document 212 into a set of chunks. This can be referred to as splitting and/or chunking. In some examples, a chunking strategy can be implemented. Example chunking strategies can include syntactic chunking and semantic chunking. Syntactic chunking can include, for example, size-based chunking and paragraph-based chunking. In some examples, size-based chunking can include splitting the requirements document 212 into chunks of a specific size. In some examples, paragraph-based chunking can include splitting the requirements document 212 at so-called end-of-paragraph characters (e.g., \n\n, \n.;). Semantic chunking can include chunking based on sentence clusters and propositional chunking. In some examples, chunking based on sentence clusters can include embedding sentences (e.g., using a pre-trained embedding model) to provide a set of sentence embeddings and grouping sentences into clusters by comparing sentence embeddings (e.g., sentences having sentence embeddings that are sufficiently similar are clustered). In this manner, each cluster can be a chunk that represents semantically similar sentences. In some examples, propositional chunking can include iteratively building chunks using an LLM (e.g., of the LLM system 206). For example, syntactic chunking can be used to define an initial set of chunks (e.g., paragraphs), generate a set of propositions by processing chunks using an LLM to provide a set of propositions.

In some implementations, syntactic recursive chunking is used, where chunking is first based on paragraph and, if the text does not contain a paragraph, then chunking is based on sentences and, if no sentences, then chunking is based on words. In this manner, related text stays together in chunks. Considering the nature of requirements documents, their structure results in requirements of one configuration being chunked together. In some examples, a fixed chunk size is not specified, as it may inhibit chunking of related text.

In some implementations, the embedder 242 provides a chunk embedding for each chunk provided from the splitter module 240. In some examples, the embedder 242 can be provided as a pre-trained machine learning (ML) model that processes chunks and, for each chunk, returns a chunk embedding. Here, a chunk embedding can be described as a multi-dimensional, numerical vector that is representative of a respective chunk in an embedding space. As noted above, each chunk and respective chunk embedding (e.g., chunk-embedding pair) is stored in the database 244.

In some implementations, the ICM retrieval component 232 includes a knowledgebase 250, an embedder 252, and a knowledge graph (KG) 254. In some examples, the embedder 252 is used in conjunction with the knowledgebase 250, which stores precomputed embeddings for each configuration settings of applications. For each configuration setting, information about the configuration can include identifier, description, and any other attribute applicable to each configuration. These are converted to embeddings by the embedder 252. As described in further detail herein, responses from the LLM system 206 for each configuration setting are passed through the respective embedding, and each entry within one configuration setting is passed as a query that is embedded. A top relevant match is selected as an intermediate response (e.g., using cosine similarity between embeddings). In some examples, the KG 254 records dependencies between configuration settings.

In the example of FIG. 2, the configuration composing module 252 includes query sets 260. In some examples, each query set 260 is specific to an application 210 and includes multiple queries (e.g., q₁, . . . , qₙ). In some examples, each query is specific to a configuration setting of the respective application 210. An application 210 can include a set of configuration settings (e.g., p₁, . . . , pₙ), and each query corresponds to a respective configuration setting. For example, a first query (q₁) can correspond to a first configuration setting (e.g., feature toggle), a second query (q₂) can correspond to a second configuration setting (e.g., languages), a third query (q₃) can correspond to a third configuration setting (e.g., parameters), and so on. In some examples, each query is a natural language query that requests configuration code for configuring a respective configuration setting, as described in further detail herein. By way of non-limiting example, an example query can include “List Languages that are default or enabled.”

In accordance with implementations of the present disclosure, the configuration composing module 234 uses a query set 260 to generate a set of prompts (e.g., PR₁, . . . , PRₙ). In some examples, the query set 260 is selected in view of the application that is to be configured (e.g., QS₁ is selected for configuring App₁, QS₂ is selected for configuring App₂, and so on). The prompts in the set of prompts are used to prompt the LLM system 206 to generate a configuration document (e.g., in Javacript object notation (JSON)) that can be used to configure an application 210. In some examples, each prompt includes a respective query and context, where the context is provided as one or more chunks of the requirements document 212.

In further detail, it can be determined that App₁ (an application 210) is to be configured for enterprise X responsive to the requirements document 212 (RD_{X}). For example, when submitting the requirements document 212, the enterprise X can indicate that App₁ is to be configured. In response, the configuration composing module 234 selects QS₁, which is the query set 260 that corresponds to App₁. For each query (q) in QS₁, the configuration composing module 234 queries the database 244 for one or more chunks that are determined to be relevant to the query. For example, for each query, a query embedding can be provided, the query embedding being a multi-dimensional, numerical vector that is representative of the query in an embedding space. In some examples, the query embedding is generated by processing the query through an embedder (e.g., that is the same as the embedder 242). Here, and by way of non-limiting example, QS₁ can include queries q₁, . . . qₙ and query embeddings qe₁, . . . qeₙ can be provided (i.e., a query embedding for each query).

The configuration composing module 234 queries the database to retrieve one or more chunks for each query that are determined to be responsive to the query. For example, the database 244 is queried using the query embeddings and, for each query embedding, one or more chunks are returned. In some examples, each query embedding is compared to each chunk embedding stored in the database 244. In some examples, comparing can include determining a similarity score between the query embedding and each chunk embedding to provide a set of similarity scores.

In some examples, the similarity score is determined as a cosine similarity between the query embedding and a chunk embedding. Cosine similarity can be described as a measure of similarity between vectors of an inner product space and is calculated as a cosine of an angle between the vectors. In some examples, the cosine similarity can be in a range of [1, −1], inclusive. Here, if two vectors are identical, the cosine similarity is equal to 1. The cosine similarity is increasingly less than 1 as the vectors being compared are increasingly dissimilar.

In some implementations, each similarity score in the set of similarity scores is compared to a threshold similarity score. If the similarity score exceeds the threshold similarity score, the respective chunk embedding is determined to be sufficiently similar to the query embedding. For each chunk embedding that is determined to be sufficiently similar to the query embedding, the chunk represented by the chunk embedding is included in a set of chunks (CH) responsive to the query. Accordingly, each query is associated with a set of chunks returned from the database 244.

Using the non-limiting example of QS₁ including q₁, . . . qₙ, the following table can be provided:

TABLE 1
Example Query Results

| QS₁ | Query Embedding | Set of Chunks |
|---|---|---|
| q₁ | qe₁ | CH₁ |
| q₂ | qe₂ | CH₂ |
| . . . | . . . | . . . |
| qₙ | qeₙ | CHₙ |

In some examples, each set of chunks includes zero or more chunks. In some examples, each set of chunks includes at least one chunk.

In accordance with implementations of the present disclosure, a set of prompts (e.g., PR₁, . . . , PRₙ) is provided, where each prompt includes a respective query and a respective set of chunks. Using the non-limiting example of Table 1, the following table can be provided:

TABLE 2
Example Prompts and Prompt Content

| Prompt | Prompt Content |
|---|---|
| PR₁ | [q₁, CH₁] |
| PR₂ | [q₂, CH₂] |
| . . . | . . . |
| PRₙ | [qₙ, CHₙ] |

In some examples, each prompt is generated using a prompt template, where the prompt template includes text and placeholders. In some examples, a placeholder can refer to a set of chunks. In some examples, a prompt template is provided for each configuration setting. By way of non-limiting example, a prompt template for language can be provided as:

Listing 1: Example Prompt

```
If ‘Language’ or ‘Languages to Enable’ not provided for in {context}, do not answer.
  Output Language only if default or enabled. output in JSON format with
    root Languages
  example {“Languages”: [“English”,“Russian”,“Dutch”]}
```

In the example of Listing 1, {contex} is a placeholder that refers to a set of chunks that are to be used as context for the prompt by the LLM system 206.

In accordance with implementations of the present disclosure, the configuration composing module 234 prompts the LLM system 206 using the set of prompts and the LLM system 206 returns a set of completions, also referred to as responses (e.g., R₁, . . . , Rₙ). In some examples, each response is provided in computer-executable code (e.g., JSON format) that is executable for configuring a respective configuration setting. Continuing with the non-limiting example above, the following example table can be provided:

TABLE 3
Example Prompts, Prompt Content, and LLM Responses

| Prompt | Prompt Content | LLM Response |
|---|---|---|
| PR₁ | [q₁, CH₁] | R₁ |
| PR₂ | [q₂, CH₂] | R₂ |
| . . . | . . . | . . . |
| PRₙ | [qₙ, CHₙ] | Rₙ |

In accordance with implementations of the present disclosure, the knowledge base (KB) 250 can be queried using one or more of the responses returned from the LLM system 206.

TABLE 4
Example LLM Results and KB Results

| LLM Result | KB Result |
|---|---|
| R₁ | KBR₁ |
| R₂ | KBR₂ |
| . . . | . . . |
| Rₙ | KBRₙ |

In some examples, the KG 254 can be queried to determine any dependencies for a configuration setting (e.g., feature toggles, parameters). That is, for example, a configuration setting can be dependent on one or more other configuration settings. Querying of the KG 254 can be used to identify such dependencies and values of the one or more configuration settings. For example, a feature toggle F1 that is to be enabled can have dependent feature toggles F2 and F3 and also dependent parameters P1 and P2, any of which can have further dependencies. The KG 254 is queried to account for such relationships.

In some implementations, the KG 254 is constructed for the purpose of extracting dependencies between the configuration settings. In some examples, the KG 254 is precomputed by feeding each entry in a source document that contains information in the form of description and/or details about dependencies to the LLM system 206. In some examples, the LLM prompt contains specific information to extract the dependent configurations and transform this context into triplets in the form of head, relationship, and tail (e.g., [F1, ‘depends on’, P1], [F1, ‘depends on’, F2]. These triplets are used to construct a directional graph that establishes the edges as relationships between the configuration nodes. The KG 254 is queried using the knowledge base results, where each configuration setting is considered a root node and a sub-graph is extracted from the KG 254, the sub-graph representing dependent configuration settings.

In some implementations, for each knowledgebase result, a KG result (KGR) is returned from the ICM retrieval component 232. Continuing with the non-limiting example above, the following example table can be provided:

TABLE 5
Example KB Results and KG Results

| KB Result | KG Result |
|---|---|
| KBR₁ | KGR₁ |
| KBR₂ | KGR₂ |
| . . . | . . . |
| KBRₙ | KGRₙ |

In some examples, a KG result includes a set of one or more dependencies corresponding to a respective configuration setting. In some examples, a KG result can be empty (e.g., the corresponding LLM result does not have any dependencies).

In some implementations, the LLM results are updated to account for any dependencies provided in the corresponding KG result. The examples of Listing 2 and Listing 3, below, illustrate updating.

Listing 2: Example JSON

```
{
  “configurations”: [
  {
    “Languages”: [
    “L1”,
    “L2”,
    “L3”
    ]
  },
  {
    “Feature Toggles”: [
    {
      “Feature”: “F1”,
      “Changed Value”: “Enable”
    }
    ]
  },
  {
    “Parameters”: [
    {
      “Parameter”: “P1”,
      “Changed Value”: “Yes”
    },
    ]
  }
  ]
}
```

Listing 3: Example Updated JSON

```
{
  “configurations”: [
    {
      “Languages”: [
      “L1”,
      “L2”,
      “L3”
      ]
    },
    {
      “Feature Toggles”: [
        {
          “Feature”: “F1”,
          “Changed Value”: “Enable”
        },
        {
          “Feature”: “F1Dep”,
          “Changed Value”: “Enable”
        }
      ]
    },
    {
      “Parameters”: [
        {
          “Parameter”: “P1”,
          “Changed Value”: “Yes”
        },
        {
          “Parameter”: “F1DepP1”,
          “Changed Value”: “Yes”
        },
      ]
    }
  ]
}
```

In accordance with implementations of the present disclosure, the LLM results (e.g., JSON snippets that include any updates in view of the KG results) can be combined into a configuration file 270 that is processed by the configuration system 236 to configure an application 210 to the particular needs of an enterprise. Continuing with the non-limiting example of the enterprise X providing the requirements document 212 for configuring App₁, the configuration file 270 (C_{1,X}) is provided, which can be executed by the configuration system 236 to configure App₁. By way of non-limiting example, a portion of an example configuration file 270 can be provided as:

Listing 4: Example Portion of Configuration File

```
{
  “configurations”: [
  {
    “Languages”: [
    “English”,
    “SimplifiedChinese”,
    “TraditionalChinese”,
    “French”
    ]
  },
  {
    “Feature Toggles”: [
    {
      “Feature”: “SINV-4915”,
      “Changed Value”: “Activate”
    },
    {
      “Feature”: “SM-14271”,
      “Changed Value”: “Turn on”
    },
    {
      “Feature”: “SM-5303”,
      “Changed Value”: “Activate”
    }
    ]
  },
  {
    “Parameters”: [
    {
    “Parameter”:
“Application.ACM.AllowFutureExpirationDateInSubAgreements”,
      “Changed Value”: “Yes”
    },
    {
      “Parameter”:
“Application.ACM.SendNotificationOnProjectStatusChange”,
      “Changed Value”: “Enable”
    },
    {
      “Parameter”: “Application.ACM.ExpiringContractReminderBegin”,
      “Changed Value”: “20”
    },
    {
      “Parameter”:
“Application.ACM.ExpiringContractReminderFrequency”,
      “Changed Value”: “10”
    },
    {
      “Parameter”: “Application.ACM.PDFAssembledDocs.Enabled”,
      “Changed Value”: “Enable”
    }
    ]
  }
  ]
}
```

In some examples, the application 210 is configured by one or more calls to an application programming interface (API).

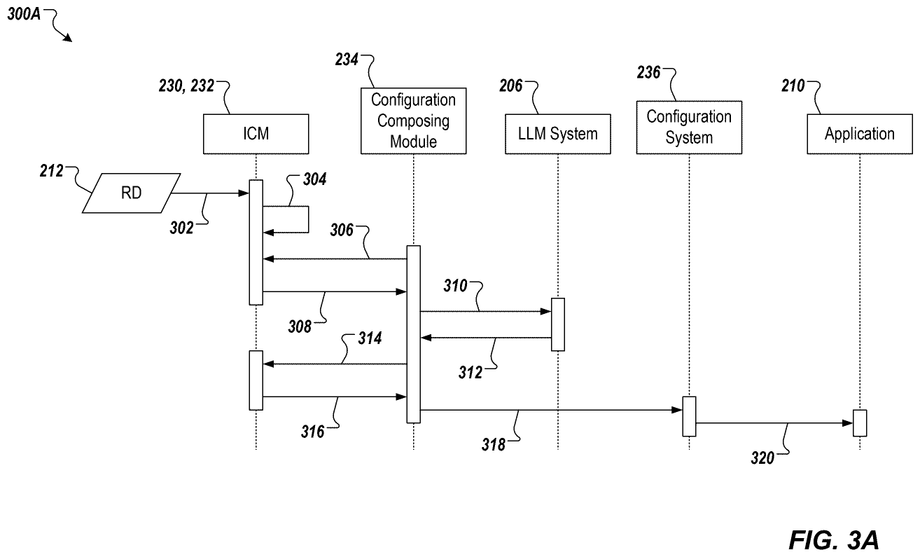

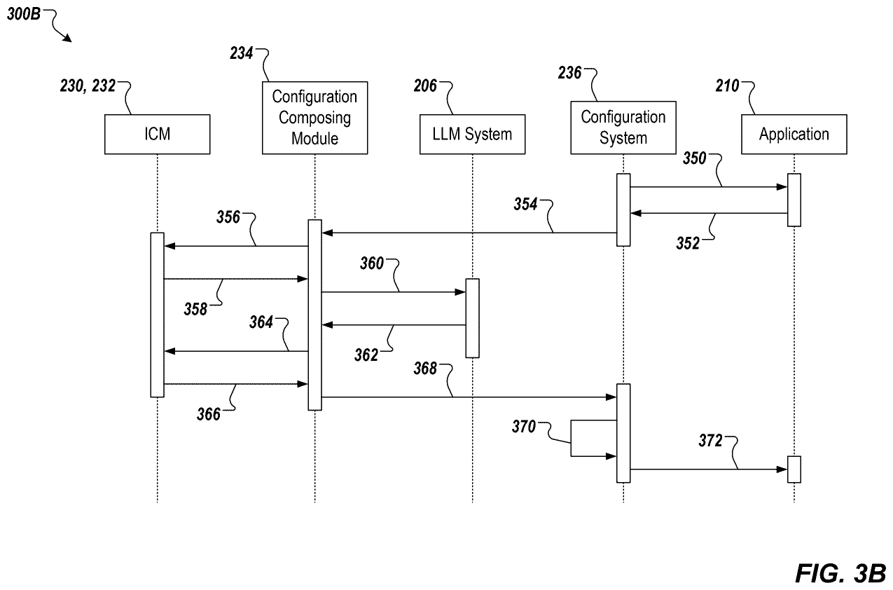

FIGS. 3A and 3B depict an example flow diagrams 300A, 300B representative of example use cases in accordance with implementations of the present disclosure.

With particular reference to FIG. 3A, the requirements document 212 is input (302) to the ICM system 230, 232, which processes (304) the requirements document 212 to generate chunk embeddings that are stored in the database 244, as described herein. The configuration composing module queries (306) the database 244 for a set of chunks for each query in a query set and the database 244 returns (308) a set of chunks for each query in the query set, as described herein. The configuration composing module 234 prompts (310) the LLM system 206 using a prompt for each query in the query set, each prompt including a respective set of chunks as context, as described in detail herein. The LLM system 206 returns (312) responses to the prompts. The configuration composing module 234 queries (314) the KG 254, which returns (316) KG results for each response received from the LLM system (312), as described herein. For example, a KG result can include one or more dependencies for a configuration setting that is the subject of a response. A configuration file is provided (318) to the configuration system (236), which processes the configuration file to configure (320) the application 210.

Implementations of the present disclosure can also provide for automated configuration of an application in response to configuration changes to the application. For example, an application can be provisioned and configured for an enterprise (e.g., per the flow of FIG. 3A) and can be used by the enterprise. In some scenarios, the application can be updated to include add one or more configuration settings (e.g., a feature is added to the application).

For example, and with particular reference to FIG. 3B, the configuration system 236 can update (350) configuration of the application 210 to add a configuration setting. The application 210 can request (352) a value for the configuration setting. The configuration system 236 can request (354) a value for the configuration setting. In some examples, the request can identify the application 210 that the configuration is to be provided for. In some examples, the request can identify an enterprise that the application 210 is configured for. The configuration composing module queries (356) the database 244 for a set of chunks for a query that corresponds to the added configuration setting and the database 244 returns (358) a set of chunks for the query. In some examples, the query is added to a pre-existing query set for the application 210 (e.g., qₙ₊₁ is added to QS₁, such that QS₁ includes q₁, . . . , qₙ, qₙ₊₁). The configuration composing module 234 prompts (360) the LLM system 206 using a prompt for the (added) query, the prompt including the set of chunks as context, as described in detail herein. The LLM system 206 returns (362) a response to the prompt. The configuration composing module 234 queries (364) the KG 254, which returns (366) KG results for the response received from the LLM system (312), as described herein. For example, a KG result can include one or more dependencies for the added configuration setting, which is the subject of the response. A configuration file is provided (368) to the configuration system 236, which request and receives (370) user approval (e.g., approval can be requested from an administrator of the enterprise), and processes the configuration file to configure (372) the application 210.

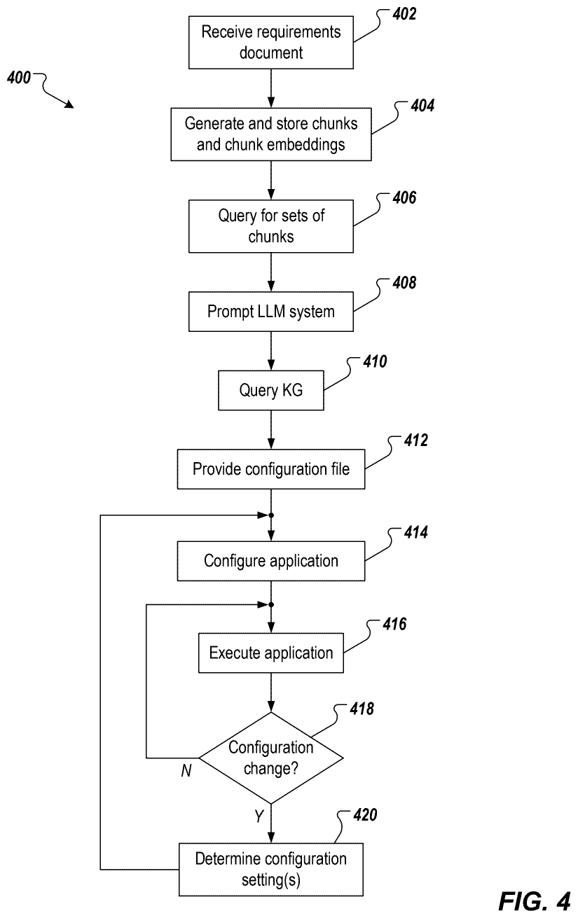

FIG. 4 depicts an example process 400 that can be executed in accordance with implementations of the present disclosure. In some examples, the example process 400 is provided using one or more computer-executable programs executed by one or more computing devices.

A document, such as a requirements document, is received (402). For example, and as described herein with reference to FIG. 2, the ICM indexing component 230 can receive the requirements document 212. In some examples, the requirements document 212 is provided for a specific enterprise, enterprise X, for configuring a specific application 210, App₁. Chunks and chunk embeddings are generated and stored (404). For example, and as described herein, the splitter module 240 splits the requirements document 212 into a set of chunks based on a chunking strategy; the embedder 242 provides a chunk embedding for each chunk provided from the splitter module 240; and each chunk and respective chunk embedding (e.g., chunk-embedding pair) is stored in the database 244.

Sets of chunks are provided responsive to queries (406). For example, and as described herein, the configuration composing module 234 selects a query set 260 that corresponds to the application that is to be configured (e.g., QS₁, which is the query set 260 that corresponds to App₁), and, for each query (q) in the query set, the configuration composing module 234 queries the database 244 for one or more chunks that are determined to be relevant to the query. For example, for each query, a query embedding can be provided, and each query embedding is compared to each chunk embedding stored in the database 244 to determine a set of chunks that is responsive to a respective query (e.g., using cosine similarity).

A LLM system is prompted (408). For example, and as described herein, the configuration composing module 234 provides a set of prompts (e.g., PR1, . . . , PRn), where each prompt corresponds to a respective query and uses a respective set of chunks as context. In some examples, each prompt is generated using a prompt template, where the prompt template includes text and placeholders. The configuration composing module 234 prompts the LLM system 206 using the set of prompts and the LLM system 206 returns a set of responses (e.g., R₁, . . . , Rₙ). In some examples, each response is provided in computer-executable code (e.g., JSON format) that is executable for configuring a respective configuration setting.

A KG is queried (410). For example, and as described herein, the configuration composing module 234 queries the KG 254 using one or more of the responses returned from the LLM system 206. In some examples, the KG 254 can be queried to determine any dependencies for a configuration setting (e.g., feature toggles, parameters). For example, the KG 254 returns a set of dependencies corresponding to one or more of the responses. A configuration file is provided (412). For example, and as described herein, the responses returned by the LLM system 206, as modified to account for any dependencies from the KG results, can be combined into the computer-executable configuration file 270. The application is configured (414). For example, and as described herein, the configuration system 236 processes the configuration file 270 to configure the application 210 to the particular needs of an enterprise. The application is executed (416). For example, the enterprise can interact with the application in support of operations of the enterprise (e.g., functions of the application being executed in support of operations).

It is determined whether there is a configuration change to the application (418). For example, and as described herein, the application is provisioned and configured for the enterprise and can be used by the enterprise. In some scenarios, the application can be updated to add one or more configuration settings (e.g., a feature is added to the application). If there is not a configuration change, the example process 400 loops back.

If there is a configuration change, configurations settings are determined (420) and the application is configured (414). For example, and as described herein with reference to FIG. 3A, the configuration composing module queries the database 244 for a set of chunks for a query that corresponds to the added configuration setting, the configuration composing module 234 prompts the LLM system 206 using a prompt for the (added) query, the prompt including the set of chunks as context, the LLM system 206 returns a response to the prompt, the configuration composing module 234 queries the KG 254, which returns KG results, and a configuration file is provided and is used by the configuration system 236 to configure the application 210.

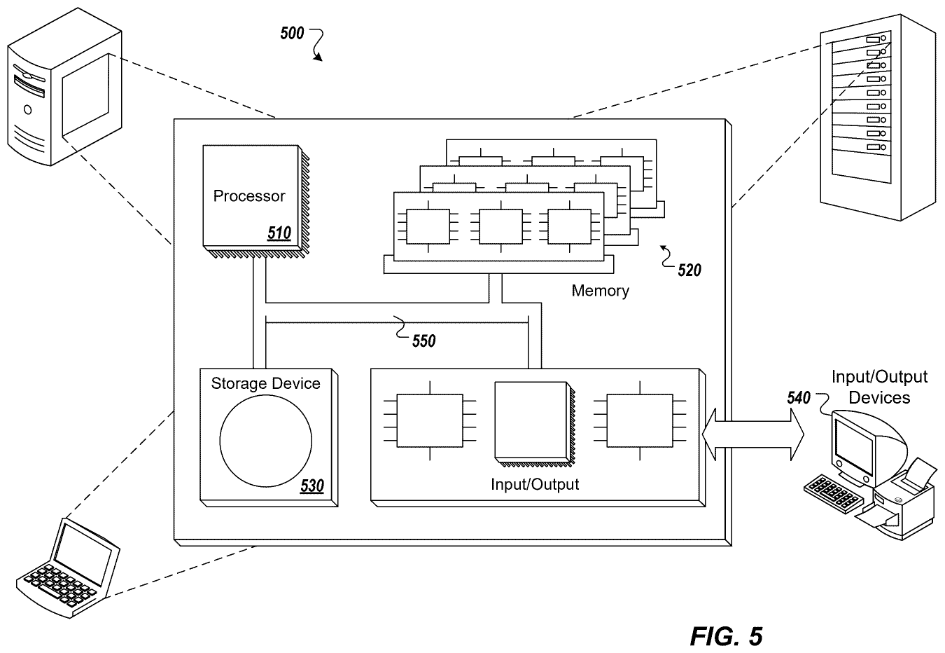

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for configuring cloud-based applications, the method being executed by one or more processors and comprising:
determining a set of queries corresponding to a set of configuration settings of an application;
for each query in the set of queries, querying a database to return a set of chunks, each chunk in each set of chunks comprising a portion of a requirements document;
providing a set of prompts, each prompt corresponding to a query in the set of queries and comprising a respective set of chunks as context;
receiving, from a large language model (LLM), a set of responses, each response corresponding to a prompt in the set of prompts;
querying a knowledge graph based on the set of responses to provide a set of knowledge graph results;
providing a configuration file using the set of responses and the set of knowledge graph results; and
configuring the application using the configuration file.

2. The method of claim 1, wherein each response in the set of responses comprises computer-executable code for a respective configuration setting in the set of configuration settings.

3. The method of claim 1, wherein each query in the set of queries comprises a natural language query corresponding to a configuration setting in the set of configuration settings.

4. The method of claim 1, wherein at least one knowledge graph result comprises a set of dependencies associated with a configuration setting in the set of configuration settings.

5. The method of claim 1, further comprising:
determining a query corresponding to a configuration setting that has been added to the set of configuration settings of the application;
querying the database to return a set of chunks responsive to the query;
providing a prompt corresponding to the query and comprising the set of chunks as context;
receiving, from the LLM, a response corresponding to the prompt; and
using the response, configuring the configuration setting that has been added to the set of configuration settings of the application.

6. The method of claim 1, wherein the query is added to the set of queries in response to addition of the configuration setting to the set of configuration settings.

7. The method of claim 1, further comprising:
providing an initial configuration file based on the set of responses; and
updating the initial configuration file using the set of knowledge graph results to provide the configuration file.

8. A non-transitory computer-readable storage medium coupled to one or more processors and having instructions stored thereon which, when executed by the one or more processors, cause the one or more processors to perform operations for configuring cloud-based applications, the operations comprising:
determining a set of queries corresponding to a set of configuration settings of an application;
for each query in the set of queries, querying a database to return a set of chunks, each chunk in each set of chunks comprising a portion of a requirements document;
providing a set of prompts, each prompt corresponding to a query in the set of queries and comprising a respective set of chunks as context;
receiving, from a large language model (LLM), a set of responses, each response corresponding to a prompt in the set of prompts;
querying a knowledge graph based on the set of responses to provide a set of knowledge graph results;
providing a configuration file using the set of responses and the set of knowledge graph results; and
configuring the application using the configuration file.

9. The non-transitory computer-readable storage medium of claim 8, wherein each response in the set of responses comprises computer-executable code for a respective configuration setting in the set of configuration settings.

10. The non-transitory computer-readable storage medium of claim 8, wherein each query in the set of queries comprises a natural language query corresponding to a configuration setting in the set of configuration settings.

11. The non-transitory computer-readable storage medium of claim 8, wherein at least one knowledge graph result comprises a set of dependencies associated with a configuration setting in the set of configuration settings.

12. The non-transitory computer-readable storage medium of claim 8, wherein operations further comprise:
determining a query corresponding to a configuration setting that has been added to the set of configuration settings of the application;
querying the database to return a set of chunks responsive to the query;
providing a prompt corresponding to the query and comprising the set of chunks as context;
receiving, from the LLM, a response corresponding to the prompt; and
using the response, configuring the configuration setting that has been added to the set of configuration settings of the application.

13. The non-transitory computer-readable storage medium of claim 8, wherein the query is added to the set of queries in response to addition of the configuration setting to the set of configuration settings.

14. The non-transitory computer-readable storage medium of claim 8, wherein operations further comprise:
providing an initial configuration file based on the set of responses; and
updating the initial configuration file using the set of knowledge graph results to provide the configuration file.

15. A system, comprising:
a computing device; and
a computer-readable storage device coupled to the computing device and having instructions stored thereon which, when executed by the computing device, cause the computing device to perform operations for configuring cloud-based applications, the operations comprising:
determining a set of queries corresponding to a set of configuration settings of an application,
for each query in the set of queries, querying a database to return a set of chunks, each chunk in each set of chunks comprising a portion of a requirements document,
providing a set of prompts, each prompt corresponding to a query in the set of queries and comprising a respective set of chunks as context,
receiving, from a large language model (LLM), a set of responses, each response corresponding to a prompt in the set of prompts,
querying a knowledge graph based on the set of responses to provide a set of knowledge graph results,
providing a configuration file using the set of responses and the set of knowledge graph results, and
configuring the application using the configuration file.

16. The system of claim 15, wherein each response in the set of responses comprises computer-executable code for a respective configuration setting in the set of configuration settings.

17. The system of claim 15, wherein each query in the set of queries comprises a natural language query corresponding to a configuration setting in the set of configuration settings.

18. The system of claim 15, wherein at least one knowledge graph result comprises a set of dependencies associated with a configuration setting in the set of configuration settings.

19. The system of claim 15, wherein operations further comprise:
determining a query corresponding to a configuration setting that has been added to the set of configuration settings of the application;
querying the database to return a set of chunks responsive to the query;
providing a prompt corresponding to the query and comprising the set of chunks as context;
receiving, from the LLM, a response corresponding to the prompt; and
using the response, configuring the configuration setting that has been added to the set of configuration settings of the application.

20. The system of claim 15, wherein the query is added to the set of queries in response to addition of the configuration setting to the set of configuration settings.
